(19) United States
(12) Patent Application Publication
(10) Pub. No.: US 2004/0135511 A1
(43) Pub. Date: Jul. 15, 2004

(54) Metal halidelamp with ceramic discharge vessel

(76) Inventors: Matthias Lenz, Falkensee (DE); Dieter Trypke, Falkensee (DE)

Correspondence Address: OSRAM SYLVANIA INC, 100 ENDICOTT STREET, DANVERS, MA, 01923, US

(21) Appl. No.: 10/718,658

(22) Filed: Nov. 24, 2003

(30) Foreign Application Priority Data
Dec. 2, 2002 (DE) 10256389.6

(51) Int. Cl. H01J 17/04

(52) U.S. Cl. 313/631

(57) ABSTRACT

A metal halide lamp having a ceramic discharge vessel with two ends which are closed off by stoppers, and an electrically conductive leadthrough guided through this stopper. An electrode with a shank secured to the leadthrough, which electrode projects into the interior of the discharge vessel. The leadthrough and electrode referred to as an electrode system, comprises two components, which are designed as pins of different diameter, the larger component being a niobium pin and the smaller component, which adjoins it on the inner, discharge side, being a pin made from molybdenum or tungsten which is fitted in a bore in the niobium pin. The ratio of the diameter of the smaller component to that of the Nb pin is between 30 and 65%, and the pin which has been fitted in is secured in the bore by a mechanical pressing operation.

### TECHNICAL FIELD

The invention is based on a metal halide lamp metal having a ceramic discharge vessel, the discharge vessel having two ends which are closed off by stoppers, and an electrically conductive leadthrough being guided through this stopper, an electrode with a shank being secured to the leadthrough, which electrode projects into the interior of the discharge vessel, the leadthrough and electrode together being referred to as an electrode system. It deals in particular with lamps with a power of 20 to 400 W, preferably of over 100 W.

### BACKGROUND ART

WO 91/09416 has disclosed a high-pressure discharge lamp in which a leadthrough comprises an Nb tube with a large diameter and a thin wall, while the electrode is formed by a pin with a small diameter. The ratio of the diameters is at least 4:1. The connection between leadthrough and electrode is produced by crimping, the crimping being carried out in such a way that a passage leading to the interior of the Nb tube, which serves as a reservoir for the fill of the discharge vessel, remains. This technique is used as standard for sodium high-pressure lamps which use a ceramic discharge vessel.

By contrast, no reservoir is required in the case of newer metal halide lamps with a ceramic discharge vessel. On the contrary, a dead volume in the region of the electrode system is as far as possible avoided. For this reason, the leadthrough and adjacent pin are provided with approximately equal diameters. The standard joining technique is in this case welding or soldering, cf. for example U.S. Pat. No. 5,557,169. However, this type of join is difficult to control, meaning that a relatively high level of scrap has to be accepted, and moreover this joining technique inherently entails high investment costs. On the other hand, reducing the level of scrap entails high costs.

### DISCLOSURE OF THE INVENTION

It is an object of the present invention to provide a metal halide lamp having a ceramic discharge vessel, the discharge vessel having two ends which are closed off by stoppers, and an electrically conductive leadthrough being guided through this stopper, an electrode with a shank being secured to the leadthrough, which electrode projects into the interior of the discharge vessel, the leadthrough and electrode together being referred to as an electrode system, the electrode system of which lamp is designed in such a way as to be simple and reliable to produce yet keeps the level of scrap at a low level.

This object is achieved by the following features: the electrode system comprises two components, which are designed as pins of different diameter, the larger component being a niobium pin and the smaller component, which adjoins it on the inner, discharge side, being a pin made from molybdenum or tungsten which is fitted in a bore in the niobium pin, the ratio of the diameter of the smaller component to that of the Nb pin being between 30 and 65%, and the pin which has been fitted in being secured in the bore by means of a mechanical pressing operation.

Particularly advantageous refinements are given in the dependent claims.

In detail, the invention deals with a metal halide lamp having a ceramic discharge vessel, the discharge vessel having two ends which are closed off by stoppers, and an electrically conductive leadthrough being guided through this elecrode stopper, an electrode with a shank being secured to the leadthrough, which projects into the interior of the discharge vessel. In the text which follows, the leadthrough and electrode together are referred to as the electrode system. The electrode system comprises at least two components, which are designed as pins of different diameter, the larger component being a niobium pin and the smaller component, which adjoins it on the inner, discharge side, being a pin made from molybdenum or tungsten which is fitted in a bore in the niobium pin, the ratio of the diameter of the smaller component to that of the Nb pin being between 30 and 65%, and the pin which has been fitted in being secured in the bore by means of a mechanical pressing operation. As an alternative to niobium, it is also possible to use an alloy with a high niobium content (for example NbZr with an Nb content of at least 60 mol %) or a metal with similar properties, in terms of its ductility, to niobium; tantalum is preferably suitable.

The mechanical pressing operation is preferably carried out by crimping or clamping. In the present context, the term crimping is to be understood as meaning local application of pressure, while the term clamping is to be understood as meaning pinching the wall of the bore all the way around.

In a preferred embodiment, the smaller component is an electrode shank made from tungsten which is fitted in the niobium pin. This may be either a long shank for a stopper capillary or a short shank (without stopper capillary).

In a further preferred embodiment, the smaller component is a pin made from molybdenum as the inner part of the leadthrough, while the niobium pin is the outer part of the leadthrough. In this case, the inner part lies in the stopper capillary, whereas the outer part is positioned at the end of the capillary.

In general, the bore is approximately 0.8 to 2.5 mm deep, so that the pin which is to be fitted in is held sufficiently securely. A preferred rule of thumb for the depth T of the bore is for it to be three to five times the diameter, in particular four times the diameter D of the pin, i.e. T=4D.

To achieve optimum fixing and securing of the smaller component, it is recommended for the bore stopper capillary, in terms of diameter, to be matched to the pin which is to be fitted in. This is the case in particular if the bore is at most 0.04 mm, preferably 0.01 to 0.025 mm, larger.

Normally, the bore has an encircling wall. Under certain circumstances, however, it may be advantageous to employ an embodiment in which the bore is slotted and has at least two tongues.

The present invention also relates to the electrode system for a metal halide lamp with ceramic discharge vessel on its own, in which the electrode system comprises two components, which are designed as pins of different diameter, the larger component being a niobium pin and the smaller component being a pin made from molybdenum or tungsten which is fitted in a bore in the niobium pin, the ratio of the diameter of the smaller component to that of the Nb pin being between 30 and 65%, and the pin which has been fitted in being secured in the bore by means of a mechanical pressing operation.

Furthermore, the present invention also covers a process for producing an electrode system which comprises two components which are designed as pins of different diameter, the larger component being a niobium pin and the smaller component being a pin made from molybdenum or tungsten, the niobium pin having a bore for receiving the smaller component, the ratio of the diameter of the smaller component to that of the Nb pin being between 30 and 65%, comprising the following process steps:

a) fitting of the smaller component into the niobium pin;

b) securing of the fitted-in pin in the bore by means of a mechanical pressing operation, in particular crimping or clamping.

The invention deals in particular with a metal halide lamp with a ceramic discharge vessel made from aluminum oxide, the discharge vessel having two ends which are closed off by ceramic stoppers. An electrically conductive, possibly two-part leadthrough, which with regard to the discharge may comprise an inner part and an outer pin-like part, is guided in a vacuum-tight manner through them. The leadthrough is a pin which on the outside is sealed at the stopper by soldering glass. The shank of an electrode, which projects into the interior of the discharge vessel, is secured to the inside of the leadthrough. The electrode may have a head which is designed as a ball, pin, shaped part or filament. Moreover, a filling filament may be fitted to the shank if a stopper capillary is used.

The power of the lamp is preferably between 70 and 400 W, although higher powers (1000 W) and lower powers (down to 20 W) are also possible.

The stopper may be of single-part or alternatively multi-part design. By way of example, it is possible, in a manner which is known per se, for a stopper capillary to be surrounded by an annular stopper part.

The leadthrough or its outer part is typically completely fused into the soldering glass over the length located within the stopper. It is important for the niobium pin to be completely covered by the soldering glass, on account of the corrosive attack from the fill.

According to the invention, the leadthrough made from Nb has a bore into which a pin made from molybdenum or tungsten is inserted on the discharge side. The bore is either provided with a continuously encircling wall or is provided with a slotted wall. It is preferably then provided with two or even more slots. The diameter of the joined pin is in this case between 30 and 65% (including boundary values) of the Nb pin. The remaining wall thickness of the Nb pin is selected in such a way that purely mechanical holding of the pin which is to be joined is possible by pressing, for example by crimping or pressing (holding by means of a press fit), on account of the materials properties of Nb. In this case, the bore is matched to the diameter of the pin which is to be joined. The bore is for this purpose preferably between 0.01 and 0.04 mm, in particular 0.015 to 0.025 mm, larger than the pin which is to be joined. The length of this pin is of no particular importance in this context. A bore with a depth of approximately 1.3 to 2.5 mm is sufficient; a depth of 1.5 to 2.0 mm is preferred, irrespective of the wattage.

In a preferred first embodiment, the leadthrough is a niobium pin with an encircling bore, since a bore can be produced easily and reliably and provides very good fixing of the pin which is to be joined.

In a second embodiment, the Nb pin is provided with a slotted bore which, although being relatively complex to produce, under certain circumstances, if appropriate at high wattages and where the pin to be joined is of relatively great weight, allows better crimping.

The fixing which can thereby be achieved is so reliable that even electrode systems with a long shank which bears a filling filament can now be made from a single piece. The defect source presented by the weld failing is now completely eliminated.

### BRIEF DESCRIPTION OF THE DRAWINGS

The invention is to be explained in more detail below on the basis of a plurality of exemplary embodiments. In the drawing:

FIG. 1 diagrammatically depicts a metal halide lamp with ceramic discharge vessel;

FIGS. 2a and 2b diagrammatically depict a detailed view of the end region of the lamp shown in FIG. 1;

FIGS. 3 to 5 diagrammatically depict further exemplary embodiments of an electrode system.

### BEST MODE FOR CARRYING OUT THE INVENTION

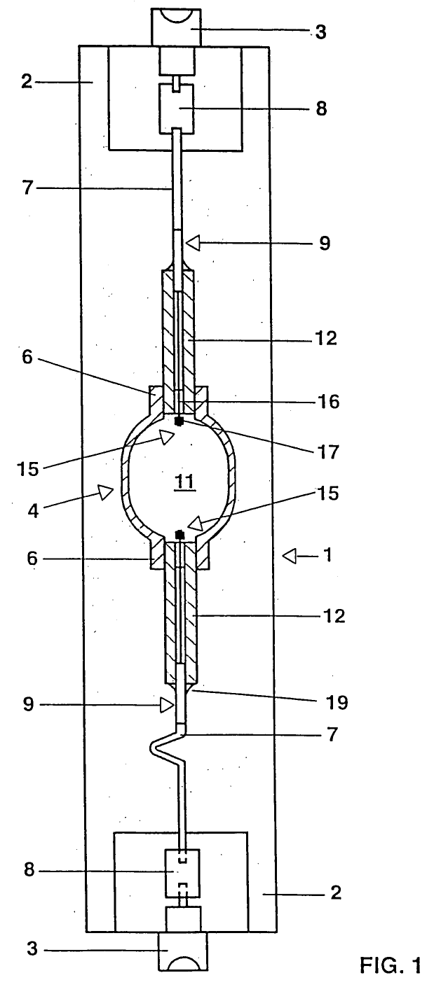

FIG. 1 diagrammatically depicts a metal halide lamp with a power of 150 W. It comprises a cylindrical outer bulb 1 which defines a lamp axis, is made from quartz glass and is pinched (2) and capped (3) on two sides. Of course, the lamp may also be closed off on one side and provided, for example, with a threaded cap. The axially arranged discharge vessel 4 made from Al₂O₃ ceramic is of cylindrical or bulging shape and has two ends 6. It is held in the outer bulb 1 by means of two supply conductors 7, which are connected to the cap parts 3 via foils 8. The supply conductors 7 are welded to leadthroughs 9, 10 which are each fitted in an end stopper 12 at the end 6 of the discharge vessel. The stopper part is designed as an elongate capillary tube 12 (stopper capillary). The end 6 of the discharge vessel and the stopper capillary 12 are, for example, directly sintered to one another. An electrode 15 is positioned on the leadthrough on the discharge side.

The leadthroughs 9, 10 are each designed as niobium pins and project into the capillary tube 12 over approximately a quarter of its length. This is followed by an extended electrode shank 16 made from tungsten, which extends inside the capillary tube 12 toward the discharge volume, with a filament 17 pushed onto the discharge-side end of the shank.

In addition to an inert firing gas, e.g. argon, the fill of the discharge vessel comprises mercury and additions of metal halides. By way of example, it is also possible to use a metal halide fill without mercury, in which case it is preferable for. the firing gas selected to be xenon and in particular. for a high pressure, well over 1.3 bar to be selected.

The niobium pin 9 is inserted into the stopper capillary 12 to a depth of approximately 3 mm and is sealed off by means of soldering glass 19. In this context, it is important for the soldering glass to completely cover this niobium pin and also for the start of the shank 16 (1 to 2 mm) also to be covered by the soldering glass.

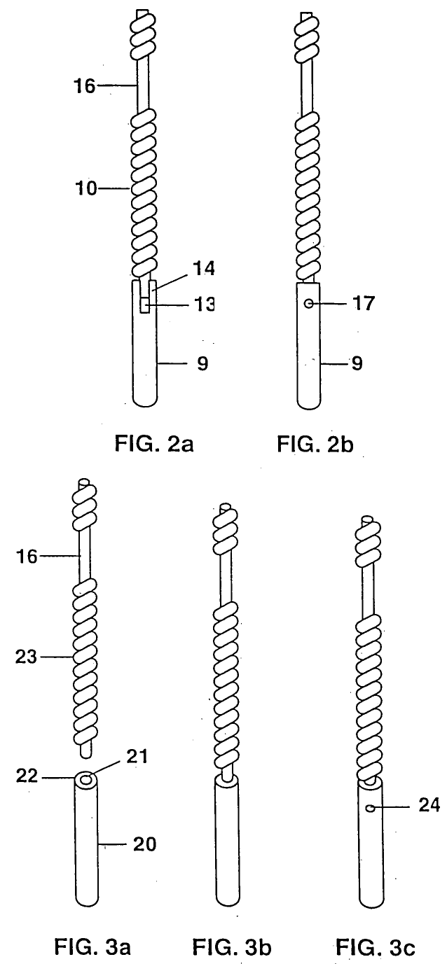

FIG. 2 shows a detailed view of the electrode system, in the form of a side view (FIG. 2a) and a further side view, rotated through 90° (FIG. 2b). A slotted niobium pin with a diameter of 0.88 mm serves as leadthrough 9. It has a bore with a depth of 2 mm and a diameter of 0.52 mm. This bore is provided with two aperture slots, so that two tongues 14 of the wall remain in place. The shank 16 made from tungsten is inserted into the bore, where it is secured by crimping (indentation 17). For the sake of clarity, the shank 16 is not shown in its fully introduced position. The crimping takes place locally at two opposite sides 17 of the two tongues 14. The diameter of the shank 16 is 0.50 mm. That part of the shank which lies in the stopper capillary is surrounded by a filling filament 10 made from molybdenum, in order to minimize the dead volume.

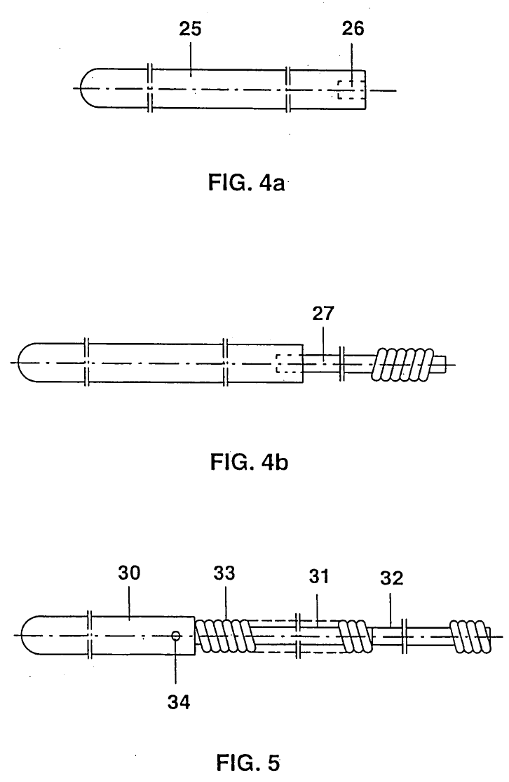

FIG. 3 shows a further exemplary embodiment of an electrode system. The leadthrough 9, 10 used is a niobium pin 20 with a diameter of 0.88 mm. The niobium pin 20 has a bore 21 with a depth of 2 mm and a diameter of 0.42 mm. This bore has an encircling wall 22 (FIG. 3a). The shank 16 made from tungsten is inserted into the bore (FIG. 3b), where it is secured by means of crimping (FIG. 3c). The crimping takes place locally at two opposite locations on the wall, where it leaves two pressure points 24. The diameter of the shank 16 is 0.40 mm. That part of the shank which lies inside the stopper capillary is surrounded by a filling filament 23 made from molybdenum in order to minimize the dead volume.

The diameter of the Nb pin and of the shank may be selected differently according to the wattage. In general, the (diameter of shank): (diameter of Nb pin) ratio is in the range from 30 to 65%, irrespective of whether a slotted arrangement or an encircling bore is used. At lower wattages, the ratio tends toward the lower limit, while at higher wattages it tends toward the upper limit. In another embodiment using molybdenum, this ratio tends to be higher than if tungsten is used, specifically approx. 30 to 50% higher, based on tungsten.

A simple exemplary embodiment, which is not intended for a stopper capillary, is shown in FIG. 4. In FIG. 4, FIG. 4a shows the Nb pin 25 on its own with the bore 26, while in FIG. 4b the short W pin 27 as electrode shank has been introduced and clamped in place.

The crimping process is also suitable, in accordance with FIG. 5, by way of example to produce a connection between the Nb pin 30 as outer part of a leadthrough and a Mo core pin 31 as inner part of a leadthrough, since in this case too the difference in size of the diameter is within the range to be employed (30 to 65%). A crimping indentation can be seen, as indicated by reference numeral 34. The core pin 31 is equipped with a filling filament 33.

However, in this case the connection between the Mo core pin 31 and the electrode shank 32 made from tungsten is to be produced in the usual way by welding, since in this case the shank to core pin size difference is too small. It is typically approximately 70 to 100%.

Table 1 shows the different ratios for further wattages. This table gives the diameter of the Nb pin (DuNb) and the diameter of the shank (DuS), both in mm, for lamps from 35 to 400 W, as well as the diameter of the shank as a percentage of the Nb pin. In these cases, a W pin was in each case used as the shank. The depth of the bore (encircling) was 2 mm.

TABLE 1

| | Power | | | | | |
|---|---|---|---|---|---|---|
| | 35 W | 70 W | 150 W | 250 W | 400 W | 150 W |
| Diameter DuNb | 0.61 A | 0.73 | 0.88 | 1.00 | 1.30 | 0.88 |
| of Nb pin (mm) | | | | | | |
| Diameter DuS of | 0.20 | 0.30 | 0.40 | 0.65 | 0.75 | 0.50 |
| W shank (mm) | | | | | | |
| Ratio between | 33% | 41% | 45% | 65% | 58% | 57% |
| DuS/DuNb | | | | | | |

What is claimed is:

1. A metal halide lamp having a ceramic discharge vessel, the discharge vessel having two ends which are closed off by stoppers, and an electrically conductive leadthrough being guided through this stopper, an electrode with a shank being secured to the leadthrough, which electrode projects into the interior of the discharge vessel, the leadthrough and electrode together being referred to as an electrode system, wherein the electrode system comprises two components, which are designed as pins of different diameter, the larger component being a niobium pin and the smaller component, which adjoins it on the inner, discharge side, being a pin made from molybdenum or tungsten which is fitted in a bore in the niobium pin, the ratio of the diameter of the smaller component to that of the Nb pin being between 30 and 65%, and the pin which has been fitted in being secured in the bore by means of a mechanical pressing operation.

2. The metal halide lamp as claimed in claim 1, wherein the mechanical pressing operation is realized by crimping or clamping.

3. The metal halide lamp as claimed in claim 1, wherein the smaller component is an electrode shank made from tungsten.

4. The metal halide lamp as claimed in claim 1, wherein the smaller component is a pin made from molybdenum as the inner part of the leadthrough.

5. The metal halide lamp as claimed in claim 1, wherein the bore is from 0.8 to 2.5 mm deep.

6. The metal halide lamp as claimed in claim 1, wherein in terms of diameter the bore is matched to the pin which is to be fitted in.

7. The metal halide lamp as claimed in claim 1, wherein the bore has an encircling wall.

8. The metal halide lamp as claimed in claim 1, wherein the bore is slotted and has at least two tongues.

9. An electrode system for a metal halide lamp with ceramic discharge vessel, wherein the electrode system comprises two components, which are designed as pins of different diameter, the larger component being a niobium pin and the smaller component being a pin made from molybdenum or tungsten which is fitted in a bore in the niobium pin, the ratio of the diameter of the smaller component to that of the Nb pin being between 30 and 65%, and the pin which has been fitted in being secured in the bore by means of a mechanical pressing operation.

10. A process for producing an electrode system which comprises two components which are designed as pins of different diameter, the larger component being a niobium pin and the smaller component being a pin made from molybdenum or tungsten, the niobium pin having a bore for receiving the smaller component, the ratio of the diameter of the smaller component to that of the Nb pin being between 30 and 65%, comprising the following process steps:
a) fitting of the smaller component into the niobium pin;
b) securing of the fitted-in pin in the bore by means of a mechanical pressing operation, in particular crimping or clamping.
